(19) United States
(12) Patent Application Publication
(10) Pub. No.: US 2026/0241541 A1
(43) Pub. Date: Aug. 20, 2026

(54) DIAGONALLY ADDRESSED MICRO-ROBOT SYSTEM

(71) Applicant: Pelrine Innovations LLC, Longmont, CO (US)

(72) Inventor: Ronald Edward Pelrine, Longmont, CO (US)

(21) Appl. No.: 19/542,556

(22) Filed: Feb. 17, 2026

Related U.S. Application Data
(60) Provisional application No. 63/759,850, filed on Feb. 18, 2025.

(51) Int. Cl. B25J 7/00; B25J 9/12; B25J 9/16

(52) U.S. Cl. CPC B25J 7/00; B25J 9/12; B25J 9/161

(57) ABSTRACT

A micro-robot system is disclosed in which printed circuit board (PCB) actuation traces are oriented diagonally relative to PCB edges to align the direction of maximum planar electromagnetic force with the primary robot motion axes. The system includes a multi-layer PCB having diagonal addressing traces driven by phase-controlled currents to generate traveling magnetic fields that propel untethered micro-robots equipped with permanent magnet arrays. The diagonal trace geometry increases planar driving force, reduces vertical clamping force and friction, and enables higher speed, improved efficiency, and reliable operation across multiple independently controlled zones. The architecture supports multi-degree-of-freedom motion, larger step sizes, reduced power consumption, and scalable parallel operation of robot swarms. The system improves performance and usability over conventional orthogonal PCB actuation by optimizing force alignment, minimizing wear, and broadening applicable surface materials and automation use cases.

### CROSS-REFERENCE TO RELATED APPLICATIONS

The present application claims benefit of priority to U.S. Provisional Patent Application No. 63/759,850, entitled “CONTROL STRATEGY AND DESIGN TO IMPROVE MICRO-ROBOT SYSTEM PERFORMANCE” and filed on Feb. 18, 2025, which is specifically incorporated by reference herein for all that it discloses or teaches.

### BACKGROUND

Robotic automation is ubiquitous across multiple industries, including space exploration, medical devices, environmental testing, and home automation, to name a few. A use of robots is in manufacturing, where repetitive motion is precisely controlled in position and force to manufacture goods. General-purpose robots are intended to execute many different processes, typically within a certain environment or range of applications. High performance is judged by robot speed and range of speed, force level, range of force, degree of precision, cost, and power requirements, for example. The suitability of a robot to execute any given process depends on multiple factors, including robot size, force, precision, speed, power, cost, etc.

Micro and mini robots are relatively recent types of general robots, offering new possibilities for automation where conventional robots may be limited. Literature describes micro-robots in many ways; our operational definition defines a micro-robot a programmable multi-degree-of-freedom (multi-DOF) mechanical device, typically with an end effector (tool) to perform useful work, and smaller than 2 cm excluding the end effector. Because of their size, micro-robot systems impact automation by enabling precise, miniature, and adaptable robotic solutions.

### SUMMARY

The presently disclosed technology relates to a micro-robot system that utilizes diagonally oriented addressing traces on a printed circuit board (PCB) to improve propulsion efficiency, reduce frictional losses, and enhance motion control of circuit-driven micro-robots. Traditional orthogonal PCB trace geometries misalign the direction of maximum planar electromagnetic force with the primary, or most frequently used, robot motion axes, resulting in lower force output, reduced speed, and increased vertical clamping forces. The disclosed system overcomes these limitations by orienting the PCB traces at a diagonal angle (approximately 45°) relative to PCB and control-zone boundaries, thereby aligning the direction of maximum planar force with the primary motion directions used in automation.

In one aspect, the system comprises a PCB including multiple layers of diagonal addressing traces, each layer selectively driven by independently controlled current sources. These traces are energized using multi-phase quadrature drive signals that generate magnetic fields capable of propelling micro-robots equipped with permanent-magnet arrays. By driving the diagonal traces with phase-controlled current sequences, the system produces traveling magnetic fields that enable precise, programmable motion along X, Y, and diagonal directions. The use of diagonal trace geometry reduces vertical clamping force—approaching zero at optimal phase lag —thereby significantly lowering friction and wear, enabling higher operational speeds, and reducing power consumption.

In another aspect, the PCB is divided into multiple independently controllable zones, each incorporating its own diagonal trace pattern. These zones may be arranged in various tessellated configurations and can be inverted relative to adjacent zones to minimize boundary effects. A host computer and driver electronics coordinate control signals so that multiple micro-robots can operate simultaneously, including cooperative swarm-style activity across numerous zones. This architecture provides a scalable platform capable of supporting large numbers of micro-robots, each capable of multi-degree-of-freedom movement.

The presently disclosed technology improves upon prior micro-robot systems by delivering higher planar force and speed in the directions most commonly used for robotic processing, providing compatibility with thicker and higher-friction worksurfaces, allowing larger and more favorable magnet orientations, and simplifying programming by maintaining alignment with conventional Cartesian frames. These improvements collectively broaden the range of feasible automation applications while enhancing reliability, efficiency, and ease of integration.

Other implementations are also described and recited herein.

### BRIEF DESCRIPTIONS OF THE DRAWINGS

FIG. 1 illustrates a first rectangular PCB having an example conventional orthogonal trace geometry contrasted with a second rectangular PCB having an example presently disclosed diagonal trace geometry.

FIG. 2 illustrates example rectangular PCB layers, each with distinct trace geometries used for circuit-driven micro-robot actuation. Conventional orthogonal X-Y trace geometries are contrasted with diagonal addressing trace geometries oriented at 45° relative to the orthogonal X-Y trace geometry and PCB edges.

FIG. 3 illustrates an example rectangular PCB with a combined orthogonal X-Y trace geometry used for circuit-driven micro-robot actuation, contrasted with a diagonal addressing trace geometry oriented at 45° relative to the orthogonal X-Y trace geometry and PCB edges.

FIG. 4 illustrates example independent control zones defined on a PCB, each zone defined by serpentine or patterned traces with a diagonal addressing trace geometry.

FIGS. 5A-5C illustrate example quadrature drive signal timing charts applied to a diagonal trace geometry producing X-Y directional micro-robot motion.

FIGS. 6A and 6B illustrate an example comparison of downward clamping force versus phase lag for conventional orthogonal (FIG. 6A) and the presently disclosed diagonal (FIG. 6B) trace systems, showing reduced Z-force for the presently disclosed design.

FIG. 7 illustrates example operations for operating a diagonally addressed circuit-driven micro-robot system.

### DETAILED DESCRIPTION

Microbotics (or micro-robotics) is the field of miniature robotics, in particular mobile robots with characteristic dimensions less than 1 mm. More generally, the term micro-robots often refers to small robots, typically less than 10-20 mm in size. Micro-robots as used herein are intended to cover any miniature robotics with a length or width dimension less than 20 mm. Micro-robots are also robots capable of handling micrometer size components. Micro-robots can be integrated into large cooperative systems, enabling them to act like bigger robots for some applications by providing higher force or additional degrees-of-freedom (DOF). By programming many robots to operate simultaneously, micro-robot systems can exhibit massive parallelism (“swarms”), able to execute many processes at once. By increasing the processed system throughput, micro-robots can offer major advantages, particularly in manufacturing applications.

There are different types of micro-robot system designs, including circuit-driven architectures. Untethered, circuit-driven micro-robots use nearby circuits to generate forces that move the robots; these may include printed circuit boards (PCBs), flex circuits, or silicon circuits. Typically, such designs include a layer of material between the circuit and micro-robots used for insulation, friction reduction, or even to levitate micro-robots to access another DOF (e.g., using diamagnetic levitation).

The propulsion force provided by the circuit can be electrostatic in some designs, or electromagnetic, typically using permanent magnets. The electrical current in the circuit's wires and traces generates a local magnetic field, which in turn exerts a force on permanent magnets in the robot. This type of micro-robot performs like a permanent magnet motor, and more specifically, a linear permanent magnet motor. These motors use a fixed set of coils (often called a stator) that magnetically drive permanent magnets in the translator, a moving element like a rotor in a rotary motor. Unlike typical linear motors, circuit-driven micro-robot systems are designed to move in more than one DOF.

These circuits often use trace patterns on multiple PCB layers that actuate or provide force in different DOFs. The presently disclosed technology generally includes four layers of traces designed to drive the micro-robots in two planar dimensions, X and Y. Two circuit layers drive the micro-robots in the X-direction, while the other two layers use orthogonal traces that drive in the Y-direction. Other types of known circuit-driven systems may have different numbers of layers and DOFs, but still adopt the presently disclosed technology.

Many micro-robots may be controlled using the top layers of a PCB, while the electronics are plugged into the bottom of the PCB. The top traces that drive the micro-robots connect to the bottom plugs for electrically coupling electronics using vias through the PCB. In these designs, micro-robots can travel untethered among zones, making most or all of the upper board surface accessible to many micro-robots and multiple micro-robot types, each with potentially different tools.

While micro-robots can move in any planar direction, it's easier to program them to move parallel and perpendicular to the edges of a rectangular PCB, as is done in the prior art. This eliminates or mitigates calculating complex angles and distances from an existing location on the PCB to another desired location when not moving parallel or perpendicular to the board edges. Further, many processes executed by micro-robots extend over the edge of the PCB, where parallel and perpendicular directions are more significant than arbitrary angles to the edge. However, the direction(s) of highest force in the prior art is often not the direction(s) of motion most used, which yields a significant limitation to performance in conventional micro-robotic systems.

The force that micro-robots can exert is limited by their size. In some cases, limited force is an advantage; for example, for safe interaction with humans or where delicacy is needed to avoid damaging products. However, micro-robot force limitations also limit the range of applications for which they are suitable. This makes any advancement able to increase available force without sacrificing other desirable characteristics (including low power requirements to minimize heating) a useful performance improvement. Besides expanding the range of micro-robot applications, higher-force smaller robots can replace lower-force larger ones, resulting in even lower power requirements and denser automation for the same tasks and potential cost savings.

Moving micro-robots in one DOF is analogous to stepper motor motion, and they can use stepper motor control variations, such as micro-stepping, variable drive amplitude, and the use of quadrature drive described herein. This stepper motion control can also borrow from motor control methods, such as the use of electronic “H-bridges” to switch current direction. Stepper motors, with only one DOF, use bearings to constrain cross-motion perpendicular to the motion of the single DOF. Micro-robots, however, utilize at least two DOF, typically using four inputs. Thus, the magnetic field provides propulsion and acts as magnetic bearings. To accomplish this in the primary X-Y directions of the rectangular PCB (i.e., directions parallel and perpendicular to the edges), conventional systems use horizontal (planar) traces perpendicular to the primary direction of motion to propel the robots; magnetic forces from traces in a parallel direction to the desired primary direction constrain against cross motion. However, this induces a continued magnetic force in a downward direction, increasing friction, which adds to wear, reduces speed, impacts power usage and performance, and can limit the surfaces and thickness on which micro-robots can operate.

The presently disclosed technology relates to circuit-driven micro-robots, untethered magnetically driven robots, multi-degree-of-freedom (multi-DOF) linear motors, automation, speed and force of the micro-robots themselves, speed of process development using micro-robot automation, and user interfaces thereof. Disclosed herein are novel trace patterns that optimize how circuit-driven microrobots are most typically used for process development in general purpose, complex micro-automation systems.

The presently disclosed technology addresses the shortcomings of existing micro-robot systems using changes in trace geometry and computer control, particularly the addressing function. Diagonal control design allows a magnetic force to provide both constraint and propulsion functions in the primary board directions, eliminating a need for downward force to provide constraint. The benefits are experienced primarily at the system level; specifically, this design increases the planar force without increasing power in the most used directions of a multi-zone, many-robot system. By changing the trace geometry of the underlying circuit, with corresponding changes in the control strategy, the highest force direction is aligned with the directions of most used motion.

This significantly increases the applicability of the micro-robot system to additional applications, increasing both available force and robot speed. As described herein, this change has additional non-obvious advantages such as reduced wear, reduced adverse effects from surface adhesion, more favorable magnet array geometries using square or rectangular magnets, and the ability to move on a greater range of surface materials and thicknesses between the circuit and robot.

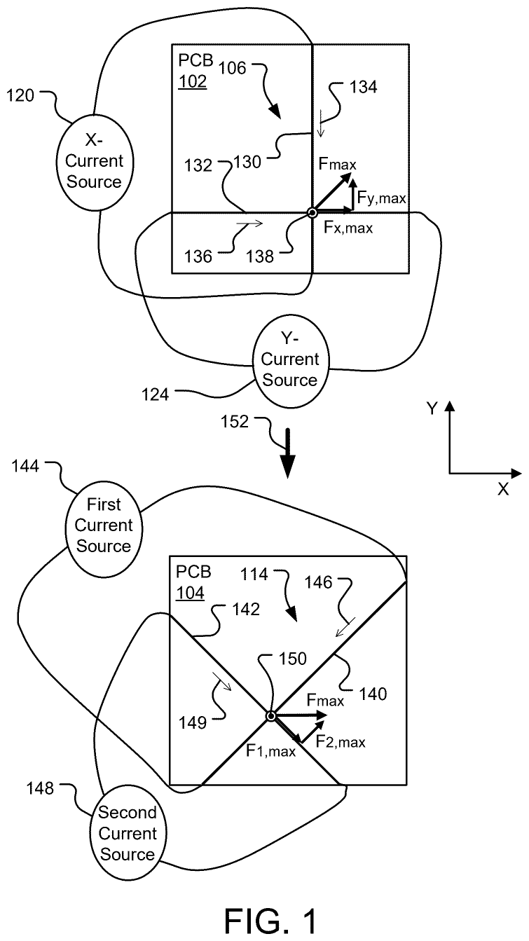

Coordinate X-Y axes are used across FIGS. 1-4 and discussed below. The X-axis generally points to the right, while the Y-axis generally points upward in FIGS. 1-4, though these directions are arbitration and used merely for convenience and convention. This axis system indicates the global reference frame used for positioning, navigation, and coordinated control across multi-zone arrays. Notably, the PCBs and control zones discussed herein are oriented with their edges parallel to the X-Y axes, and the orthogonal trace geometries are similarly oriented so that their maximum motive force Fₘₐₓ is also applied parallel to the X-Y axes, as discussed in detail below.

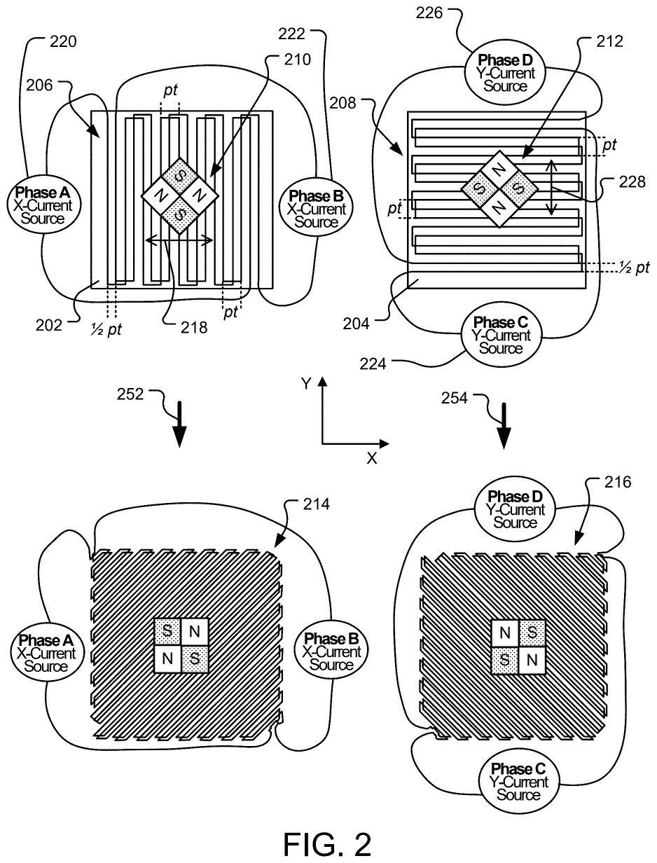

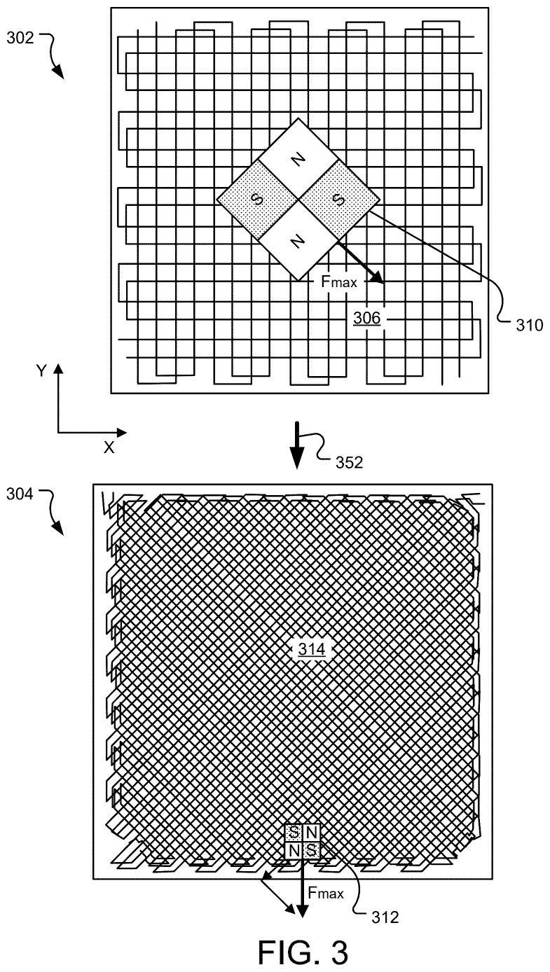

FIG. 1 illustrates a first rectangular PCB 102 having an example conventional orthogonal trace geometry 106 and a second rectangular PCB 104 having an example presently disclosed diagonal trace geometry 114. Each of the trace geometries 106, 114 may be used to drive motion of a permanent magnet micro-robot (not shown, see e.g., micro-robots 210, 212 of FIG. 2 positioned above the PCBs 102, 104). Only a singular trace for each of the trace geometries 106, 114 is shown bisecting the rectangular PCBs 102, 104, respectively, for purposes of illustrating the resulting maximum motive forces (e.g., Fₓₘₐₓ, F_{ymax}, and Fₘₐₓ). In practice, the trace geometries 106, 114 are more complex to drive a particular desired motion of the micro-robots both in direction and distance across the PCBs 102, 104 as illustrated in FIGS. 2 and 3 and discussed in further detail below.

The PCB 102 includes a first conductive trace 130 arranged in the y-direction and a second conductive trace 132 arranged in the x-direction, both within and below a top surface of the PCB 102. An X-Current Source 120 drives current through the first conductive trace 130, as illustrated by arrow 134. A Y-Current Source 124 drives current through the second conductive trace 132, as illustrated by arrow 136. The X-Current Source 120 is capable of driving x-direction motion of the micro-robot, while the Y-Current Source 124 is capable of driving motion of the micro-robot in the Y-direction.

The maximum lateral force, Fₘₐₓ running parallel to a surface of the PCBs 102, 104 driven by the trace geometries 106, 114 (from traces or wires below the surface of the PCBs 102, 104) occurs for a vertically oriented dipole when the point dipole is directly over the center of the trace or wire.

Using the principles of linear superposition that apply to strong (high coercivity) magnets and electrical currents, the maximum planar force that can be exerted on a point dipole occurs when the dipole is directly over the crossing point of the two traces 130, 132, here point dipole 138, and the maximum force direction is oriented diagonal (approximately 45 degrees) to both the traces 130, 132. This maximum diagonal force, Fₘₐₓ, is Fₘₐₓ=1.414 Fₚ, where Fₚ=F_{x,max}=F_{y,max} (the maximum force perpendicular to the traces 130, 132). The factor 1.414=2^{0.5} is the well-known ratio of leg to hypotenuse for a right triangle, as illustrated in FIG. 1. Notably, in the conventional orthogonal trace geometry 106, Fₘₐₓ is directed diagonally with reference to the PCB 102 edges, which are generally oriented in the x-direction and y-direction.

Arrow 152 indicates a logical transformation from the orthogonal X-Y trace geometry 106 into the diagonal trace geometry 114 oriented at 45° relative to the orthogonal X-Y trace geometry 306. This logical transformation is provided to compare and contrast the orthogonal X-Y trace geometry 106 with the diagonal trace geometry 114, not to suggest that an actual transformation from the X-Y trace geometry 106 to the diagonal trace geometry 114 occurs in a particular implementation.

The PCB 104 also includes a first conductive trace 140 and a second conductive trace 142. However, the conductive traces 140, 142 are arranged 45 degrees from the x-direction and y-direction, as depicted, both also within and below a top surface of the PCB 104. A First Current Source 144 drives current through the first conductive trace 140, as illustrated by arrow 146. A Second Current Source 148 drives current through the second conductive trace 142, as illustrated by arrow 149. The Current Sources 144, 148 are capable of driving x-direction and y-direction motion of the micro-robot when used in combination.

As discussed above, the maximum planar force that can be exerted on a point dipole occurs when the dipole is directly over the crossing point of the two traces 140, 142, here point dipole 150 in FIG. 1, and the maximum force direction is oriented diagonally (approximately 45 degrees) to both the traces 140, 142. This maximum diagonal force, Fₘₐₓ, is Fₘₐₓ=1.414 Fₚ, where Fₚ=F_{1,max}=F_{2,max} (the maximum force perpendicular to the traces 140, 142). Notably, in the presently disclosed diagonal trace geometry 114, Fₘₐₓ is directed in the x-direction, which is generally aligned with two of the PCB 104 edges. A similar Fₘₐₓ may be generated in the positive y-direction, negative x-direction, and negative y-direction using the traces 140, 142, all of which are aligned with the PCB 104 edges, which are also generally oriented in the x-direction and y-direction. Aligning Fₘₐₓ with the PCB 104 edges yields technical advantages as compared to an Fₘₐₓ directed diagonally with reference to the PCB 102 edges, as discussed in detail below.

FIG. 2 illustrates example rectangular PCB layers 202, 204, each having corresponding conventional orthogonal trace geometries 206, 208, which may be used for driving motion of permanent magnet micro-robots 210, 212 (illustrated in FIG. 2 by diamond-oriented permanent-magnet arrays) positioned above the PCB layers 202, 204. Each of the conventional orthogonal trace geometries 206, 208 illustrated in the upper images of FIG. 2 may be logically converted to the presently disclosed diagonal trace geometries 214, 216, respectively, which are illustrated in the lower images of FIG. 2. A combined conventional orthogonal trace geometry 306 and a combined presently disclosed diagonal trace geometry 314 are each shown in FIG. 2 and described in detail below.

The PCB layer 202 includes a rectangular set of generally parallel conductive traces arranged vertically within the depicted control zone (trace geometry 206). Two distinct current sources, a first X-Current Source 220 driving Phase A, and a second X-Current Source 222 driving Phase B, are shown driving alternating traces within the PCB layer 202. Each of the X-Current Sources used in concert, with a phase offset between the Phase A and the Phase B, are capable of driving motion of the micro-robot 210 in the x-direction, as illustrated by arrow 218.

Similarly, the PCB layer 204 includes a rectangular set of generally parallel conductive traces arranged horizontally within the depicted control zone (trace geometry 208). Two additional distinct current sources, a first Y-Current Source 224 driving Phase C, and a second Y-Current Source 226 driving Phase B, are shown driving alternating traces within the PCB layer 204. Each of the Y-Current Sources used in concert, with a phase offset between the Phase C and the Phase D, are capable of driving motion of the micro-robot 212 in the y-direction, as illustrated by arrow 228.

The alternating traces within each of the trace geometries 106, 114 are spaced at a separation of 1 pt. The trace geometry 206 shows how a quadrature drive with 2 layers of X-traces are used to drive the magnetic array in the X-direction. Phase A and Phase B are offset by ½ pt. Denoting current in these two traces as +1 for positive current (defined by the Current Sources 220, 222) and −1 as negative current going in the opposite direction, then (+1, +1) connotates currents going in the positive direction in both phases. The Quadrature drive then drives the robot in the X-direction by sequentially driving a repeating current sequence such as (+1, +1), (−1, +1), (−1, −1), (+1, −1), (+1, +1), (−1, +1), (−1, −1), (+1, −1), (+1, +1). Each current state (i, j) is held to allow the robot time to respond (e.g., 1-100 ms). For pt=1 mm, the step size between each current step is 0.5 mm using the conventional orthogonal trace geometries 206, 208 shown. Phases C and D are similar but rotated 90 degrees to give Y-direction motion. By combining all 4 traces and compensating trace current for differences in trace depth as needed, the system can drive in both X and Y directions, or even in off-axis directions by phasing or combining X and Y drive currents.

The diamond-oriented permanent-magnet array (the micro-robots 210, 212) are positioned above the trace geometries 206, 208 on the PCB layers 202, 204. The magnet's poles alternate around the diamond (N-S-N-S), forming a checkerboard orientation. Other magnet array types, such as Halbach arrays, can be used, so long as the magnet dipole pitch, pm, is approximately the square root of 2 times the trace pitch pt (the distance to the neighboring parallel traces). That is, pm=1.414 pt. While the trace and magnet geometries are more complex than the single trace and point dipole example described above, detailed analysis using superposition indicates that the highest lateral drive force still occurs in a diagonal direction relative to the repeating patterns of orthogonal traces.

Since the zone boundaries are parallel/perpendicular to the traces in the conventional orthogonal trace geometries 206, 208, the maximum force (Fₘₐₓ) is oriented diagonally to the zone boundaries for the orthogonal trace geometries 206, 208. Lastly, in many zone systems (e.g., systems with greater than 10 zones), square zones are stacked parallel and perpendicular to the PCB boundary, and hence the strongest force is again diagonal to the system PCB boundaries.

Arrows 252, 254 indicate a logical transformation from the orthogonal X-Y trace geometries 206, 208 into the diagonal trace geometries 214, 216 oriented at 45° relative to the orthogonal X-Y trace geometries 206, 208. This logical transformation is provided to compare and contrast the orthogonal X-Y trace geometries 206, 208 with the diagonal trace geometries 214, 216, not to suggest that an actual transformation from the X-Y trace geometries 206, 208 to the diagonal trace geometries 214, 216 occurs in a particular implementation.

The conventional orthogonal X and Y trace geometries 206, 208 are each converted to the diagonal trace geometries 214, 216 oriented at 45° relative to the orthogonal X-Y trace geometry and PCB edges. Trace geometry 206 slants in one diagonal direction, while trace geometry 216 slants in the opposite diagonal direction. In combination, the trace geometries 206, 208 form full two axis diagonal control of the micro-robot.

Both diagonal trace geometries 214, 216 may be applied to a similar square region as PCB layers 202, 204, yielding square regions filled with parallel diagonal hatching, indicating that the effective drive traces, after superposition of phases, form a diagonal (non-orthogonal) effective actuation pattern. Together, as illustrated in FIG. 3, the two diagonal patterns of trace geometries 206, 208 represent the pair of orthogonal diagonal drive modes used in the improved micro-robotic control scheme disclosed herein.

FIG. 3 illustrates a first example rectangular PCB 302 with a combined orthogonal X-Y trace geometry 306 used for circuit-driven micro-robot actuation, contrasted with a diagonal trace geometry 314 oriented at 45° relative to the orthogonal X-Y trace geometry 306 and PCB edges as presently disclosed, applied to a second example rectangular PCB 304. FIG. 3 further demonstrates the impact of trace geometry and its interaction with permanent-magnet micro-robots 310, 312 (illustrated in FIG. 3 by diamond-oriented permanent-magnet arrays), demonstrating how two orthogonal trace sets combine into a unified drive pattern, using both the conventional trace geometry 306 and the presently disclosed diagonal trace geometry 314.

PCB 302 is illustrative of a single rectangular control zone formed by a grid of perpendicularly oriented conductive traces forming the X-Y trace geometry 306. The X-Y trace geometry 306 includes multiple X-direction traces, evenly spaced, as discussed with reference to conventional orthogonal trace geometry 206 of FIG. 2. The X-Y trace geometry 306 further includes multiple Y-direction traces, also evenly spaced, as discussed with reference to conventional orthogonal trace geometry 208 of FIG. 2. The trace geometries 206, 208 of FIG. 2 may be combined to form the X-Y trace geometry 306 of FIG. 3 with an outer perimeter boundary of the PCB 302 defining the control zone dimensions.

Centered within this grid is a diamond-shaped permanent-magnet array representing the micro-robot 310. The array consists of four square magnets arranged at 45° relative to the grid, forming a rotated square. Two opposite magnets are labeled N, the other two labeled S, indicating the alternating magnetic pole pattern that interacts with the magnetic fields generated by trace currents. By selectively varying the current applied to the X-Y trace geometry 306, the micro-robot 310 moves in specific directions across the PCB 302.

Arrow 352 indicates a logical transformation from the orthogonal X-Y trace geometry 306 into the diagonal trace geometry 314 oriented at 45° relative to the orthogonal X-Y trace geometry 306. This logical transformation is provided to compare and contrast the orthogonal X-Y trace geometry 306 with the diagonal trace geometry 314, not to suggest that an actual transformation from the X-Y trace geometry 306 to the diagonal trace geometry 314 occurs in a particular implementation.

PCB 304 is illustrative of a single rectangular control zone formed by a grid of diagonally oriented conductive traces forming the diagonal trace geometry 314. The diagonal trace geometry 314 includes multiple traces, evenly spaced, slanting in one diagonal direction, as discussed with reference to diagonal trace geometry 214 of FIG. 2. The diagonal trace geometry 314 further includes multiple traces, evenly spaced, slanting in an opposite (perpendicular) diagonal direction, as discussed with reference to diagonal trace geometry 216 of FIG. 2. The trace geometries 214, 216 of FIG. 2 may be overlaid within separate layers and combined to form the diagonal trace geometry 314 of FIG. 3 with an outer perimeter boundary of the PCB 304 defining the control zone dimensions.

The diagonal trace geometry 314 further depicts a resulting composite actuation pattern produced when diagonal current-driven trace sets operate in a coordinated multi-phase fashion. The effective pattern of the diagonal trace geometry 314 is represented as a dense diagonal mesh, comprising a grid of crisscrossing diagonal lines. These diagonals run in two opposing (orthogonal) directions, illustrating the superposition of the vector fields created by the orthogonal diagonal trace sets. This combined pattern corresponds to the diagonal force-optimized geometry used in the presently disclosed and improved micro-robot control.

Along one edge of the PCB 304, the micro-robot 310 (illustrated as a small checkerboard magnet array (labeled S-N/N-S)) is shown above the diagonal trace geometry 314. The magnet array represents the micro-robot's magnetic structure relative to the effective diagonal field orientation. The depicted micro-robot 310 orientation emphasizes how the micro-robot 310 aligns and responds to the resultant diagonal magnetic gradients of the diagonal trace geometry 314 rather than the X-Y trace geometry 306 of the PCB 302.

The maximum diagonal force exerted on the micro-robot 310, Fₘₐₓ, in the conventional orthogonal trace geometry 306, is directed diagonally with reference to the PCB 302 edges, which are generally oriented in the x-direction and y-direction. In contrast, the maximum diagonal force exerted on the micro-robot 312 in the presently disclosed diagonal trace geometry 314 is directed in the negative y-direction, which is generally aligned with two of the PCB 304 edges. A similar Fₘₐₓ may be generated in the positive y-direction, negative x-direction, and positive x-direction using the diagonal trace geometry 314, all of which are aligned with the PCB 304 edges, which are also generally oriented in the x-direction and y-direction. Aligning Fₘₐₓ with the PCB 304 edges yields technical advantages as compared to an Fₘₐₓ directed diagonally with reference to the PCB 302 edges, as discussed herein.

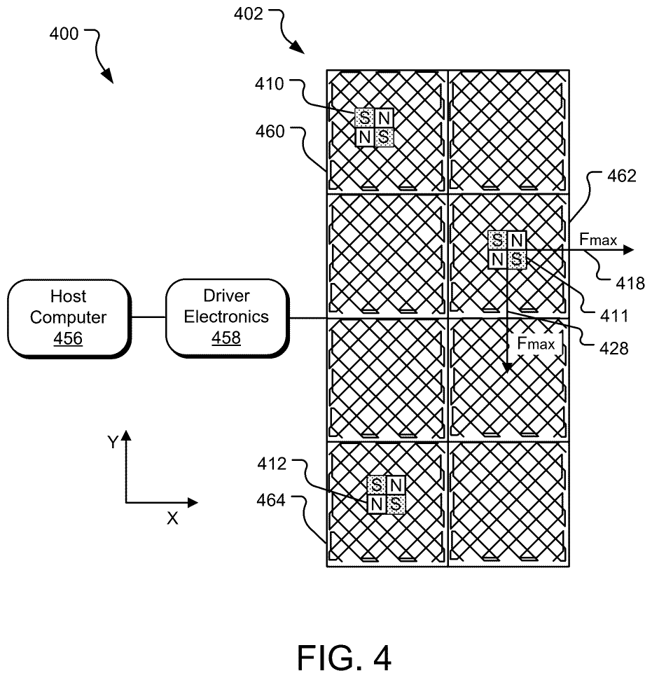

FIG. 4 illustrates example independent control zones (e.g., control zones 460, 462, 464) defined on a PCB 402, each zone defined by patterned traces laid out in a serpentine fashion with a diagonal addressing trace geometry. The PCB 402 is used as part of a multi-zone micro-robot actuation system 400, where a Host Computer 456 coordinates with driver electronics 458 to control multiple adjacent diagonal-trace control zones, each capable of independently or cooperatively driving circuit-propelled micro-robots (e.g., micro-robots 410, 411, 412).

With massive parallelism (“swarms”), the micro-robots may execute many processes at once, which can greatly increase system 400 throughput. Circuit-driven micro-robots execute this strategy using independent control zones, such as control zones 460, 462, 464. An independent control zone is an area of the circuit that can independently control a micro-robot. Many independent control zones can be fabricated and operated on a single circuit board, such as PCB 402, using modern electronics and batch fabrication. While PCB 402 includes a 2×4 array of 8 control zones, in other implementations, greater or fewer control zones may be included on a single PCB. For example, as many as 144 control zones could be fabricated on a single printed circuit board, though there is no fundamental upper limit.

The Host Computer 456 generates high-level movement commands, processes sensor or task data, and coordinates the actions of the micro-robots 410, 411, 412 operating across the array of control zones. The Driver Electronics 458 receives control instructions from the Host Computer 456 and converts them into phase-controlled electrical drive signals. These signals power the diagonal addressing traces located in each control zone. A communication link is shown between the Host Computer 456, the Driver Electronics 458, and the PCB 402, representing data and command flow.

Each of the control zones is depicted with a dense diagonal cross-hatch pattern, representing the effective diagonal trace geometry that produces optimized magnetic propulsion forces for micro-robot movement. The cross-hatching emphasizes that each zone contains superposed diagonal addressing traces, which, in operation, generate Fₘₐₓ in the X-Y directions, as discussed above.

Three micro-robots 410, 411, 412, each represented by a small checkerboard permanent-magnet array labeled with alternating “S” and “N” poles, are positioned in separate control zones (control zones 460, 462, 464, respectively). Each of the micro-robots 410, 411, 412 are illustrated as a square four-magnet assembly, reflecting the alternating north-south pattern integral to magnetic actuation. Arrow 418 extends from the micro-robot 411 in control zone 462, indicating Fₘₐₓ and an intended direction of motion in the x-direction. Similarly, arrow 428 also extends from the micro-robot 411, indicating Fₘₐₓ and an intended direction of motion in the y-direction. In sum, arrows 418, 428 demonstrate how robots can be translated between zones or within individual zones using diagonal-trace magnetic fields and X-Y directional movements. Arrows 418, 428 also illustrate that the diagonal-trace magnetic fields generate Fₘₐₓ forces in the X-direction and the Y-direction, which is parallel to the control zone boundaries, and the boundaries of the PCB 402 itself.

Using square or rectangular zones, as illustrated, it is far easier to program motion parallel or perpendicular to the zone boundaries. More specifically, circuit-driven micro-robots can be programmed to move in any direction, such as the shortest path between two points, but it is by far easier and faster for the user to program them in directions orthogonal to the square zone boundaries because it eliminates or mitigates the need for the user to estimate angles and distances. It is also common for micro-robots to work over the edge of the PCB 402 for fabrication, testing, etc. of objects that cannot conveniently be placed directly on the micro-robot PCB worksurface, or when the object is macro or has a large vertical extent and needs to be moved using macro-translation stages or macro-robots.

The diagonal direction relative to orthogonal traces gives the highest force (for fixed current/power) and highest speeds, as discussed above, yet prior art systems have the weakest force and slowest speeds in the most important directions perpendicular and parallel to both the zone and system boundaries. The presently disclosed technology uses a novel trace geometry, as shown, oriented the traces diagonally, rather than parallel/perpendicular, to the zone and system boundaries, makes the system 400 faster and higher force in important and commonly used directions along with additional benefits described elsewhere herein. The addressing scheme is modified to achieve the benefits of the presently disclosed diagonal addressing trace geometry.

Overall, the multi-zone micro-robot actuation system 400 illustrates a Host Computer 456 driven micro-robot positioning architecture, multi-phase Driver Electronics 458, and a eight-zone diagonal-trace actuation array capable of moving micro-robots 410, 411, 412 among adjacent control zones. FIG. 4 demonstrates how diagonal trace geometry is employed across multiple zones to support scalable, multi-robot automation under centralized computer control and taking advantage of Fₘₐₓ intentionally oriented parallel to control zone and PCB 402 boundaries.

Trace widths and trace spacing can be designed in various ways with diagonal trace systems. In one implementation, using 4 layers of copper traces with approximately 2 mil insulation between them, trace widths are 0.7 mm with 0.3 mm spaces (pt=1 mm). This implementation uses low power per zone but requires different levels of drive current for each of the 4 layers since the deeper layers require more current to apply the same magnetic force as the shallower layers. The same layer of traces, but for different zones, can be driven in series, however, if H-bridge switches are used to independently control the current direction.

Moving the permanent-magnet micro-robots 410, 411, 412 across zone boundaries requires a careful layout for best performance. For example, neighboring zones trace layouts may be flipped relative to each other so as to effectively cancel the boundary segments. The flipped zone can be described as the original zone rotated 180 degrees about an in-plane axis going from bottom to top of the PCB 402, followed by counterclockwise rotation of 90 degrees about an axis perpendicular to the PCB 402. The segments connecting the longer traces may have minimal width and spacing for best results. In one implementation, the boundary segments are 0.2 mm in width with 0.15 mm spaces between zones, though other widths and spaces can be used depending on the circuit fabrication limits.

Just as it is possible to reduce the current in a coil by using multiple turns, it is possible to adjust the current needed to achieve a given force (within limits) by adjusting the trace width and using 2-turn serpentine trace patterns. In this way, all layers can be driven with the same level of current, simplifying the electronics. In one implementation, with pt=1 mm, which can be driven at a single current level, the top two layers use trace widths of 0.77 mm and 0.43 mm for top and next layer down, respectively. The third layer is a two-turn pattern using 0.37 mm width traces with 0.13 mm spaces and the fourth layer uses a two-turn pattern with trace width 0.23 mm and trace spacing of 0.13 mm between traces with the same current direction.

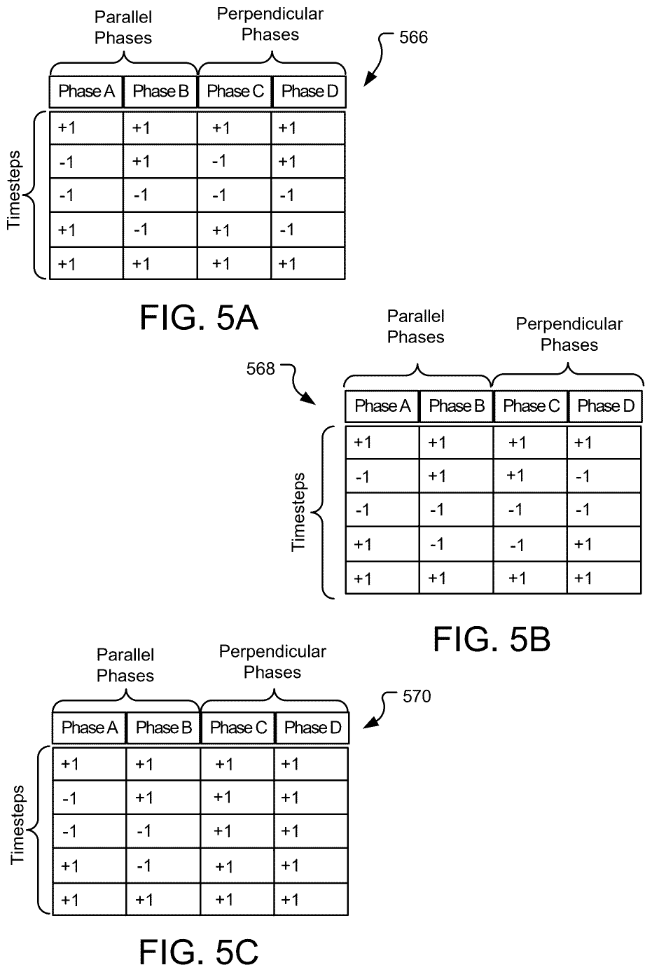

FIGS. 5A-5C illustrates example quadrature drive signal timing charts 566, 568, 570 applied to a diagonal trace geometry producing X-Y directional micro-robot motion. The timing charts 566, 568, 570 further illustrate a multi-phase actuation timing scheme for driving the X-Y directional micro-robot motion. FIGS. 5A-5C each depict a timing matrix that defines how different electrical drive phases vary over successive timesteps to produce commanded robot motion, specifically X-direction motion, Y-Direction motion, and X-Y diagonal motion, respectively.

The X-Y directions are referenced relative to PCB and control zone edges, as shown and discussed with reference to FIG. 4, not relative to the trace directions. As such, there are parallel and perpendicular phases (replacing no longer “X” phases and “Y” phases in a convention addressing scheme), with one direction of diagonal traces being identified as “Parallel” and the perpendicular traces labeled as “Perpendicular”. Addressing the traces using the conventional addressing patterns for pure X-direction and pure Y-direction movement using a conventional orthogonal X-Y trace geometry generate diagonal motion relative to the zone and board axis using a diagonal trace geometry. All of tables 566, 568, 570 of FIGS. 5A-5C demonstrate synchronized multi-phase modulation across timesteps, coordinated to drive micro-robots on diagonal trace systems, as discussed in further detail below.

FIG. 5A shows a first four-phase timing table 566 for X-direction motion using Phase A, Phase B, Phase C, and Phase D. The Phases A-D are grouped into Parallel Phases (Phase A and Phase B) and Perpendicular Phases (Phase C and Phase D). A vertical axis of the table 566 is labeled Timesteps, indicating that each horizontal row corresponds to a discrete time increment in the actuation sequence. Within the table 566, each cell contains either +1 or −1, representing the polarity or direction of current applied to that phase during the corresponding timestep. The pattern proceeds through alternating signs in a structured sequence, demonstrating a multi-phase quadrature-style drive pattern that produces X-direction motion along when applied to the presently disclosed diagonal trace geometry.

FIG. 5B shows a second four-phase timing table 568 for X-direction motion using Phase A, Phase B, Phase C, and Phase D. The Phases A-D are similarly grouped into Parallel Phases (Phase A and Phase B) and Perpendicular Phases (Phase C and Phase D). A vertical axis of the table 568 is similarly labeled Timesteps. Within the table 568, each cell similarly contains either +1 or −1, representing the polarity or direction of current applied to that phase during the corresponding timestep.

However, the pattern of signs of FIG. 5B differs from that of FIG. 5A. Here, the polarity sequence is shifted such that certain phases invert at different timesteps, enabling a modified force vector output. This difference in sequencing provides an alternate drive pattern capable of producing movement along a different commanded direction, here the Y-direction. Thus, the pattern proceeds through alternating signs in a structured sequence, demonstrating a multi-phase quadrature-style drive pattern that produces Y-direction motion along when applied to the presently disclosed diagonal trace geometry.

FIG. 5C shows a fourth-phase timing table 570 for diagonal motion using Phase A, Phase B, Phase C, and Phase D. The Phases A-D are similarly grouped into Parallel Phases (Phase A and Phase B) and Perpendicular Phases (Phase C and Phase D). A vertical axis of the table 568 is similarly labeled Timesteps. Within the table 570, each cell similarly contains either +1 or −1, representing the polarity or direction of current applied to that phase during the corresponding timestep.

However, the pattern of signs of FIG. 5C differs from that of FIGS. 5A and 5B. The polarity sequence is again shifted such that certain phases invert at different timesteps, enabling a modified force vector output. This difference in sequencing provides an alternate drive pattern capable of producing movement along a different commanded direction, here the X-Y diagonal direction. Thus, the pattern proceeds through alternating signs in a structured sequence, demonstrating a multi-phase quadrature-style drive pattern that produces diagonal motion along when applied to the presently disclosed diagonal trace geometry.

Depending on how the Phases A-D are sequenced relative to one another, the resulting magnetic fields at the diagonal traces produce different combinations of planar force components. The depicted drive pattern sequences may be repeated to drive additional motion of the micro-robot in the desired direction. FIGS. 5A-5C illustrates the generality of the control approach and demonstrates that precise robot trajectories can be generated by adjusting the timing polarity of each phase.

FIGS. 5A-5C provide multiple phase-timing tables 566, 568, 570 that govern how micro-robot propulsion fields are generated via controlled current waveforms. Each of the tables 566, 568, 570 have parallel and perpendicular phase groupings, reflecting how diagonal trace geometries use coordinated multi-axis phase control. The three distinct polarity-timing sequences of tables 566, 568, 570 each produce different planar movement effects through modulation of the magnetic force vector. The tables 566, 568, 570 collectively demonstrate a phase-controlled drive logic used to actuate X-Y or diagonal motion of circuit-driven micro-robots using diagonal-trace control zones.

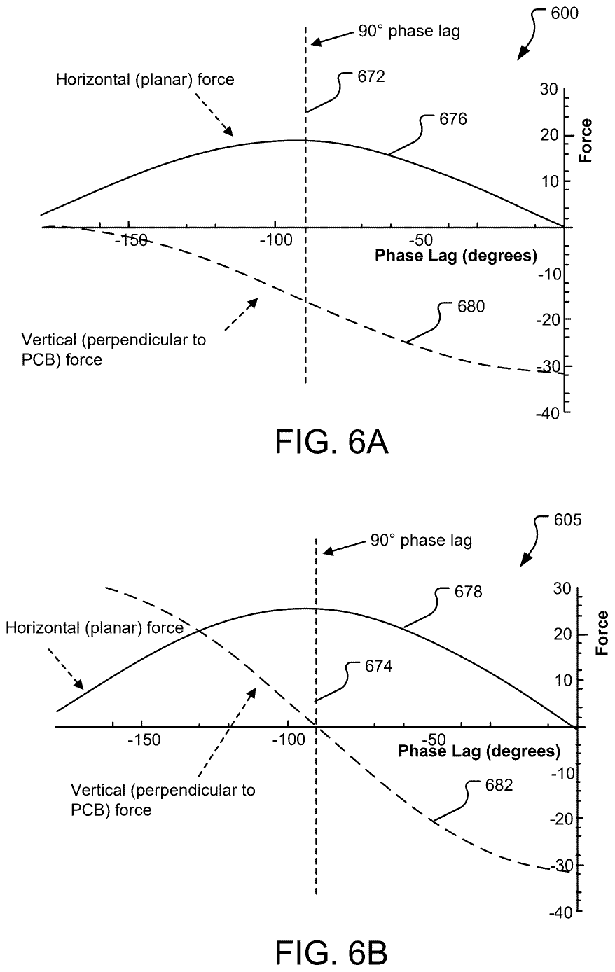

FIGS. 6A and 6B illustrate an example comparison of downward clamping force versus phase lag for conventional orthogonal (FIG. 6A) and the presently disclosed diagonal (FIG. 6B) trace systems, showing reduced Z-force for the presently disclosed design. More specifically, FIG. 6A and FIG. 6B show the relationship between phase lag in multi-phase electrical drive signals and the resulting magnetic forces acting on a circuit-driven micro-robot. Each of graphs 600, 605 depicts how horizontal (planar) forces and vertical (perpendicular-to-PCB) forces vary as the phase difference between drive signals changes. Both of the graphs 600, 605 share common axes (Phase lag and Force) and annotation styles, enabling direct comparison between different drive conditions and control scenarios.

Graphs 600 of FIGS. 6A and 6B each presents a two-curve plot of force, with both horizontal (or planar with a PCB)) and vertical (or perpendicular to the PCB) force depicted. The horizontal axes represent Phase Lag (in degrees), labeled from approximately −150° on the left through −100°, −50°, and approaching 0° at the right. The vertical axes represent Force, with positive values extending upward (0, +10, +20, +30) and negative values downward (−10, −20, −30, −40). Dashed vertical lines 672, 674 mark −90° phase lag, a point at which horizontal (planar) force peaks and thus performance transitions occur.

Curve 676 of graph 600 is a solid, generally convex curve labeled Horizontal (planar) force that shows that the planar force increases as phase lag approaches −90°, reaches its peak around 20 units at −90° near the center of the graph 600, and then decreases again as the phase lag approaches 0°. This curve 676 illustrates how optimal planar force is achieved near a specific phase-lag value (often near −90° quadrature in circuit-driven micro-robot systems) in conventional orthogonal trace systems.

Curve 678 of graph 605 is also a solid, generally convex curve labeled Horizontal (planar) force that shows that the planar force increases as phase lag approaches −90°, reaches its peak at 90° near the center of the graph 600, and then decreases again as the phase lag approaches 0°. Curve 678 peaks higher than Curve 676 (approximately 30 units vs. 21 unit) illustrating higher peak force Fₘₐₓ achievable in the X-Y directions using the presently disclosed diagonal trace systems as compared to the conventional orthogonal trace systems. This curve 678 also illustrates how optimal planar force is achieved near a specific phase-lag value (similarly near 90° quadrature in circuit-driven micro-robot systems) in the presently disclosed diagonal trace systems.

Curve 680 of graph 600 is a dashed curve labeled Vertical (perpendicular to PCB) force that shows negative force values across the entire range (indicative of −z-direction force or force pulling a micro-robot into the PCB), force magnitude increasing (or becoming more negative) as phase lag moves from −150° to 0°. This demonstrates that vertical clamping force is significant at or near favorable phase-lag values (e.g., approximately −15 units at −90° phase lag), increasing friction and causing a more difficult micro-robot motion.

Curve 682 of graph 605 is also a dashed curve labeled Vertical (perpendicular to PCB) force that shows force values across the entire range (indicative of z-direction force pushing the micro-robot away from the PCB or pulling a micro-robot into the PCB). The force magnitude starts at a positive magnitude near 30 units at −150°, decreases toward zero magnitude at a −90° phase lag, and then increases again in negative magnitude as phase lag moves from −90° to 0°.

This demonstrates that vertical clamping force is significant at phase-lag values approaching 0°, while a significant negative clamping force occurs approaching −150°, potentially pushing the micro-robot off of the PCB. In between, at approximately −90° phase lag, the vertical clamping force approaches 0 units, which minimizes friction. This allows for less force to be required to move the micro-robot and a smoother operation of the micro-robot overall. Also significant is that the point at which the vertical clamping force approaches 0 units is the same or similar point where the peak force Fₘₐₓ occurs, both at −90° phase lag.

The applied force perpendicular to the circuit (“vertical”) affects friction and wear. The Graph 600 shows the applied vertical force as well as the applied horizontal (planar) force which drives the micro-robot forward in the X direction (defined relative to the rectangular PCB). This Graph 600 plots force versus phase lag using a simple point dipole model. In a stepper type drives, the equilibrium point is displaced electronically to cause the micro-robot to move. The equilibrium points are periodic in space with period D, and distance of the robot from the equilibrium point is normally expressed as a phase lag in degrees, ang, where ang=360*s/D, where s is the distance from equilibrium. The peak applied force Fₘₐₓ for propulsion nominally occurs when the phase lag is roughly 90 degrees, as seen in curves 676, 678. This is also the instantaneous phase lag when the quadrature drive is instantaneously switched to the next step when the micro-robot starts in the at-rest, equilibrium position. However, in this type of micro-robot drive, there is also a perpendicular or vertical force which pulls the micro-robot into the substrate (or pushes it away). For conventional drives, this force is negative (pulling against the substrate) and is only near zero when the horizontal force is also near zero when moving in the board's X direction, and similarly for moving the board's Y direction, as illustrated by curve 680.

In contrast, the forces for moving the micro-robot in the board's X direction using a diagonal trace board of the presently disclosed technology is shown in graph 605. The peak horizontal force Fₘₐₓ is larger for the diagonal board, as discussed above. However, the force pulling the micro-robot against the PCB is less than the corresponding pulling vertical force (in magnitude) for all points except 0 phase where it is equal. Hence, the friction force, which is nominally proportional to the pulling force in magnitude, is less for the diagonal trace board, thereby reducing wear and enabling higher speeds. When the quadrature drive is instantaneously switched to move the micro-robot from rest in an equilibrium position, the phase lag jumps to 90 degrees where the vertical force is zero. This is in contrast to the conventional board, which has a significant pulling force against the board at 90 degrees phase lag.

This phenomenon exacerbates adhesion (“static friction”) in conventional systems, but the diagonal trace system is less susceptible to adhesion preventing the micro-robot from starting to move in the most commonly used directions (e.g., X-Y direction). This phenomenon also allows the diagonal trace system to use thicker and higher friction worksurfaces between the PCB and the micro-robot, a significant non-obvious advantage. While it is true these benefits are most pronounced in the most commonly used directions (parallel and perpendicular to the board's edges), they make the micro-robot system as a whole more reliable and useful, particularly for general-purpose applications. Phase lags greater than 90 degrees may be unstable without feedback for both conventional and diagonal trace systems, but with the diagonal trace system, the micro-robot may be repelled off the PCB surface and can go airborne if the vertical force exceeds the micro-robot weight.

The lower clamping and repulsive (phase lag>90 degrees) force of the presently disclosed technology vs. the phase lag of the prior art allows higher friction and thicker surfaces to be used in the PCB's X and Y directions. The system can even operate in these directions on high-friction sandpaper and on other surfaces over 1 mm thick (e.g., with a 1 mm pitch=pt). On surfaces where both types of systems can operate, the presently disclosed technology can operate as much lower current and power than conventional systems. Although this is only true when the robot moves in the PCB's or zone's X and Y directions, these are the most commonly used directions, leading to significant improvements to system operation in many automation applications.

In sum, FIGS. 6A and 6B visualize the tradeoff between planar driving force and vertical clamping force, and how that depends on phase-lag timing in multi-phase actuation. The graph 605 shows a distinct region (at or near −90° phase lag) where planar force is maximized while vertical force is minimized. Thus, optimal micro-robot performance typically occurs near the specific phase-lag region where planar force is maximized, vertical clamping force is minimized (reducing friction), and the resulting motion is efficient and stable. Graph 605 provides the analytical basis for selecting phase-timing strategies for diagonal-trace micro-robot systems as disclosed herein.

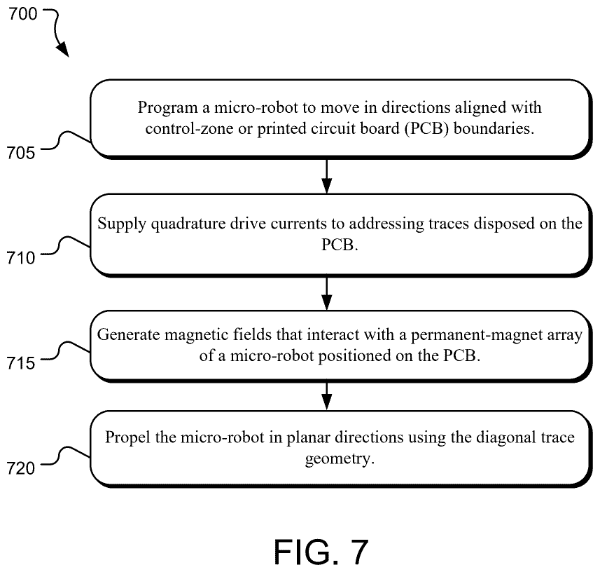

FIG. 7 illustrates example operations (or method) 700 for operating a diagonally-addressed circuit-driven micro-robot system. The circuit-driven micro-robot system includes a printed circuit board (PCB) having a plurality of independent control zones. Each control zone comprises addressing traces patterned on one or more PCB layers. Unlike prior orthogonal trace systems in which the drive traces run parallel to the board edges, the addressing traces of the present system are oriented diagonally with respect to both the boundaries of the individual control zones and the overall PCB boundaries.

A population of untethered micro-robots is supported on or above a worksurface overlying the PCB. Each micro-robot includes a permanent-magnet array, for example, a checkerboard array of permanent magnets arranged in a diamond orientation, configured to interact with magnetic fields produced by currents driven through the addressing traces. The system can include a host computer and driver electronics that collectively generate and apply phase-controlled drive currents to selected groups of addressing traces in each control zone.

A programming operation 705 programs a micro-robot to move in directions aligned with control-zone or PCB boundaries to simplify process development. A host computer presents the user with a coordinate system in which the X- and Y-axes are aligned with the edges of rectangular control zones and the edges of the PCB. The user specifies robot motion in terms of displacements and trajectories parallel or perpendicular to these boundaries, such as straight-line moves along the sides of zones, moves between adjacent zones, or motion that extends over an outer edge of the PCB to access a work object positioned off-board.

A motion-planning module converts the requested motions into corresponding sequences of phase states for the quadrature drive signals. Because the diagonal addressing traces have been laid out so that the directions of highest planar force coincide with the directions parallel and perpendicular to the zone and PCB boundaries, the controller can execute these user-defined, axis-aligned moves with high force and speed. This alignment both increases performance and simplifies process development, by allowing the user to work in a natural, rectangular coordinate frame without needing to calculate arbitrary angles or compensate for reduced force in the most commonly used directions.

A supplying operation 710 supplies quadrature drive currents to addressing traces disposed on a printed circuit board (PCB). The addressing traces are oriented diagonally relative to control-zone and PCB boundaries. To operate the system, the controller supplies quadrature drive currents to the addressing traces disposed on the PCB. In one implementation, four electrical phases (Phase A, Phase B, Phase C, and Phase D) are defined. Two of the phases are associated with a first set of diagonal traces that predominantly contribute force in a first planar direction (parallel to a selected PCB boundary), while the remaining phases are associated with a second set of diagonal traces that predominantly contribute force in a perpendicular planar direction. Timing tables such as those shown in FIGS. 5A-5C specify, for a sequence of timesteps, the polarity (+1/−1) of current supplied to each phase, thereby implementing quadrature drive signals distributed across the diagonal trace sets. During operation, the driver electronics step through the sequence of phase states, supplying time-varying, phase-shifted currents to the traces. The currents are in quadrature, for example approximately 90 degrees out of phase, so that the resultant magnetic field pattern translates smoothly across the diagonal trace geometry.

A generating operation 715 generates magnetic fields that interact with a permanent-magnet array of a micro-robot positioned on the PCB. The quadrature drive currents generate magnetic fields that extend through the work surface and interact with the permanent-magnet array of each micro-robot positioned within a control zone. Because the traces are oriented diagonally with respect to the controlzone and PCB boundaries, the superposition of fields from the different phases produces a resultant planar propulsion force whose maximum magnitude is aligned with directions parallel and perpendicular to the PCB boundaries. In contrast, prior orthogonal systems provide maximum force along diagonal directions that are not aligned with the board edges.

A propelling operation 720 propels the micro-robot in planar directions using the diagonal trace geometry. The diagonal orientation of the addressing traces aligns a direction of maximum planar propulsion force with directions parallel and perpendicular to the PCB boundaries. As the controller advances the quadrature phase pattern, the location of the magnetic field gradients relative to the permanent-magnet array changes, producing a net horizontal (planar) force on the robot. The robot is thereby propelled in planar directions across the worksurface using the diagonal trace geometry. The diagonal trace design also permits the same currents to provide both propulsion and lateral constraint, while reducing vertical clamping force for a given planar force, as illustrated by force-phase curves such as those in FIGS. 6A and 6B.

Thus, the method 700 supplies quadrature drive currents to diagonally oriented addressing traces, generating magnetic fields that interact with the robot's permanent-magnet array, and propelling the robot in planar directions where the direction of maximum planar propulsion force is aligned with directions parallel and perpendicular to the PCB boundaries.

In some implementations, the propelling operation 720 propels multiple micro-robots simultaneously and independently across multiple control zones. The PCB may implement many independent control zones, for example, tens or hundreds of zones tessellated across the board. Each control zone has its own diagonal addressing traces and can be driven independently by the driver electronics.

In operation, the host computer maintains a representation of the position and assignment of each micro-robot to a given control zone. Motion commands for different robots are translated into separate phase sequences for the respective zones. The driver electronics multiplex or parallelize the quadrature drive currents so that multiple micro-robots are propelled simultaneously and independently across multiple control zones, while still benefiting from the diagonal trace geometry that aligns maximum planar force along the board-aligned directions.

The method 700 can include moving robots from one control zone into an adjacent control zone by continuing the appropriate quadrature sequence as the robot crosses the zone boundary, thereby allowing robots to traverse the entire PCB and to participate in cooperative tasks or swarm-style operations.

Benefits of the presently disclosed “diagonal trace systems” over the prior art include the following: (a) higher horizontal (planar) micro-robot force in the most commonly used directions for a given power; higher micro-robot speed in the most commonly used directions for a given power; (b) lower power (and heating) for the same speed and force in the most commonly used directions; lower clamping vertical force for given horizontal force in the most commonly used directions, thereby reducing friction, wear, and further enhancing speed and horizontal force; (c) magnet arrays more favorably oriented in typical operating conditions using square magnets (e.g., square magnets move point-first moving in X and Y in prior art's stable orientations, but flat-face moving in X and Y directions using diagonal trace systems; (d) larger step size (e.g., 0.7 mm vs. 0.5 mm) in X and Y directions which can make registration and adjustment of linked micro-robots easier; an ability to use a greater range of worksurface materials and thicknesses (located between the micro-robot and the PCB); (e) the worksurface or part thereof can be a product itself (e.g., micro-robots working directly on a flex circuit produce while driven by an underlying PCB), or designed to enhance other aspects such as a surface for greater wear or for diamagnetic levitation); and preserves the ease of use and ease/speed of developing processes using square zones and rectangular boards.

The logical operations of the present invention may be implemented (1) as a sequence of processor-implemented steps executed in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, the logical operations may be performed in any order, adding and omitting as desired, unless explicitly claimed otherwise or a specific order is inherently necessitated by the claim language.

The above and attached specification, examples, and data provide a complete description of the structure and use of example implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. The implementations described above, and other implementations are within the scope of the following claim.

Although focused on general purpose automation, the invention described herein can also be applied to custom or more specialized automation by using traces that are diagonal to the dominant direction or force used in the specialized application rather than diagonal to the board edges.

What is claimed is:

1. A micro-robot system comprising:
a printed circuit board (PCB) including a plurality of addressing traces arranged within one or more control zones, the addressing traces being oriented diagonally relative to boundaries of the control zones and to boundaries of the PCB; and
one or more circuit-driven micro-robots positioned on or above the PCB, each micro-robot including a permanent-magnet array configured to interact with magnetic fields generated by drive currents applied to the addressing traces to propel the micro-robots, wherein the diagonal orientation of the addressing traces aligns a direction of maximum planar propulsion force with directions parallel and perpendicular to the PCB boundaries.

2. The micro-robot system of claim 1, wherein the PCB includes at least four layers of addressing traces, the addressing traces within each layer being a serpentine arrangement primarily extending diagonally relative to boundaries of the control zones and to boundaries of the PCB.

3. The micro-robot system of claim 2, wherein each of the four layers of addressing traces are driven by separate current sources, each with a distinct phase.

4. The micro-robot system of claim 2, wherein each of the four layers of addressing traces are powered at different levels of drive current.

5. The micro-robot system of claim 1, wherein the diagonal orientation of the addressing traces yields approximately zero units of vertical clamping force.

6. The micro-robot system of claim 5, wherein maximum planar propulsion force and the zero units of vertical clamping force both occur at approximately 90 degrees phase lag.

7. The micro-robot system of claim 1, wherein the PCB includes an array of independently driven control zones.

8. The micro-robot system of claim 1, wherein the PCB is greater than 1 mm thick with greater than a 1 mm pitch.

9. A method of operating a circuit-driven micro-robot system, the method comprising:
supplying quadrature drive currents to addressing traces disposed on a printed circuit board (PCB), the addressing traces being oriented diagonally relative to control-zone and PCB boundaries;
generating magnetic fields that interact with a permanent-magnet array of a micro-robot positioned on the PCB; and
propelling the micro-robot in planar directions using the addressing traces, wherein the diagonal orientation of the addressing traces aligns a direction of maximum planar propulsion force with directions parallel and perpendicular to the PCB boundaries.

10. The method of claim 9, further comprising:
programming the micro-robot to move in directions aligned with control-zone or PCB boundaries to simplify process development.

11. The method of claim 9, further comprising:
propelling multiple micro-robots simultaneously and independently across multiple control zones.

12. The method of claim 9, wherein the diagonal orientation of the addressing traces yields approximately zero units of vertical clamping force.

13. The method of claim 12, wherein maximum planar propulsion force and the zero units of vertical clamping force both occur at approximately 90 degrees phase lag.

14. A micro-robot system comprising:
a rectangular printed circuit board (PCB) including an array of independent control zones, each control zone comprising a least four sets of diagonal addressing traces, all of which oriented at approximately 45° relative to edges of the PCB;
vias electrically coupling the diagonal traces to driver electronics on one side of the PCB;
a micro-robot oriented on an opposite side of the PCB, the micro-robot including a checkerboard permanent-magnet array configured to be driven by magnetic fields produced by the diagonal traces; and
the driver electronics configured to apply quadrature drive signals to the diagonal traces to propel the micro-robot, wherein the diagonal orientation of the addressing traces aligns a direction of maximum planar propulsion force with directions parallel and perpendicular to PCB and control zone boundaries.

15. The micro-robot system of claim 14, wherein the PCB includes at least four layers of addressing traces within each of the control zones, the addressing traces within each layer being a serpentine arrangement primarily extending diagonally relative to boundaries of the control zones and to boundaries of the PCB.

16. The micro-robot system of claim 15, wherein each of the four layers of addressing traces are driven by separate current sources, each with a distinct phase.

17. The micro-robot system of claim 15, wherein each of the four layers of addressing traces are powered at different levels of drive current.

18. The micro-robot system of claim 14, wherein the diagonal orientation of the addressing traces yields approximately zero units of vertical clamping force.

19. The micro-robot system of claim 18, wherein maximum planar propulsion force and the zero units of vertical clamping force both occur at approximately 90-degrees phase lag.

20. The micro-robot system of claim 14, wherein trace layouts for two neighboring zones are flipped relative to each other to cancel shared boundary segments.
